(19) United States
(12) Patent Application Publication
(10) Pub. No.: US 2026/0105201 A1
(43) Pub. Date: Apr. 16, 2026

(54) SYSTEM AND METHOD FOR HUMAN-IN-THE-LOOP SIMULATED ANNEALING

(71) Applicant: TOYOTA RESEARCH INSTITUTE, INC., Los Altos, CA (US)

(72) Inventors: Nikos ARECHIGA GONZALEZ, San Mateo, CA (US); Emily S. SUMNER, Mountain View, CA (US); Shabnam HAKIMI, San Francisco, CA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/913,880

(22) Filed: Oct. 11, 2024

(51) Int. Cl. G06F 30/13; G06F 30/27; G06F 111/06; G06N 3/0475

(52) U.S. Cl. CPC G06F 30/13; G06F 30/27; G06N 3/0475; G06F 2111/06

(57) ABSTRACT

A method for innovative design with a simulated annealing process includes presenting a human product designer with multiple product designs by randomly sampling an embedding space of a generative AI model to receive rating and feedback from the human product designer. The method includes generating a fitness function over the embedding space of the generative AI model. A score estimation model is fitted on scored latent vectors of the embedding space to assign a high/low probability to the samples with a high/low score from the human product designer. The method includes employing a simulated annealing process to generate innovative designs in response to feedback and preferences of the human product designer. The score estimation model is modified by multiplying variances of the score estimation model by a current temperature T, and renormalization. The method includes exploring a design space of the generative AI model according to the score estimation model.

### BACKGROUND

### Field

Certain aspects of the present disclosure relate to machine assisted design and, more particularly, to a system and method for human-in-the loop simulated annealing.

### BACKGROUND

Visual content creators may utilize image curation tools to provide an online platform for creating and highlighting their creative work. For example, image curation tools such as PINTEREST® and BEHANCE® are the de facto standard tools used by designers to inspire their work. Nevertheless, exploring a design space involves a manual and aimless process, which is not provided by these image creation tools. In practice, visual content creators first begin their creative process (e.g., concept sketches) by aimlessly searching or scrolling through images in diverse topics (e.g., fashion, architecture, product design, etc.). This searching/scrolling process is followed by iteratively narrowing down the topic, scope, and focus of the search as the visual content creators increase the fidelity of their designs.

Generative artificial intelligence (AI) tools excel in producing novel and unconventional designs; however, generative AI tools can fall short in generating designs that serve as effective starting points for the design process. In practice, a designer begins with an abstract idea or feeling that they want to express in a product and uses it as a text “seed” for the product. A process of applying machine learning and behavioral science to assist a single designer, a group of customers, or a company to collectively land on a design idea, is desired.

### SUMMARY

A method for innovative design with a simulated annealing process includes presenting a human product designer with multiple product designs by randomly sampling an embedding space of a generative AI model to receive rating and feedback from the human product designer. The method includes generating a fitness function over the embedding space of the generative AI model. A score estimation model is fitted on scored latent vectors of the embedding space to assign a high/low probability to the samples with a high/low score from the human product designer. The method includes employing a simulated annealing process to generate innovative designs in response to feedback and preferences of the human product designer. The score estimation model is modified by multiplying variances of the score estimation model by a current temperature T, and renormalization. The method includes exploring a design space of the generative AI model according to the score estimation model.

A system for generating an innovative design with a simulated annealing process using a generative artificial intelligence (AI) model is described. The system includes a designer feedback module to present a human product designer with multiple product designs, produced by randomly sampling an embedding space of the generative AI model, to receive rating and feedback from the human product designer. The system also includes a score estimation model to generate a fitness function over the embedding space of the generative AI model. A score estimation model is fitted on scored latent vectors of the embedding space to assign a high/low probability to the samples with a high/low score from the human product designer. The system further includes a simulated annealing process module to employ a simulated annealing process to generate innovative designs in response to feedback and preferences of the human product designer. The score estimation model is modified by multiplying variances of the score estimation model by a current temperature T, and renormalization. The system also includes a design space exploration module to explore, by the human product designer, a design space of the generative AI model identified according to the score estimation model.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC) of a visual content creation system, in accordance with aspects of the present disclosure.

FIG. 2 is a block diagram illustrating an exemplary software architecture that may modularize artificial intelligence (AI) functions for a visual content design system, according to aspects of the present disclosure.

FIG. 3 is a diagram illustrating a hardware implementation for a visual content design system, according to aspects of the present disclosure.

FIGS. 4A and 4B are block diagrams illustrating a visual content design recommendation system, according to various aspects of the present disclosure.

FIG. 5 is a process flow diagram illustrating a method for generating an innovative design with a simulated annealing process using a generative artificial intelligence (AI) model, according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Visual content creators may utilize image curation tools to provide an online platform for creating and highlighting their creative work. For example, image curation tools such as PINTEREST® and BEHANCE® are the de facto standard tools used by designers to inspire their work. Nevertheless, exploring a design space involves a manual, undirected process, which is not supported by these image creation tools. In practice, visual content creators first begin their creative process (e.g., concept sketches) by aimlessly searching or scrolling through images in diverse topics (e.g., fashion, architecture, product design, etc.). This searching/scrolling process is followed by iteratively narrowing down the topic, scope, and focus of the search as the visual content creators increase the fidelity of their designs.

In practice, designers are often given abstract words (e.g., rugged, sleek, dependable, exciting) and faced with the task of translating these abstract words into creative designs. Designers may interpret these words in diverse ways, impacting how the designs are embodied visually throughout the design process. For example, a typical design prompt such as “make this part rugged and pop” could be interpreted differently depending on the designer's domain expertise (e.g., interior vs. exterior design) as well as regional and cultural context (e.g., mass vs. luxury markets).

Presenting people with visual alternatives can enhance design creativity by allowing them to consider options of which they may not otherwise think. Nevertheless, these suggestions must fit into a person's workflow and within a reasonable distance from the person's interpretation of the design parameters. For instance, some design parameters may elicit prioritization of functional features while others may rely more on aesthetic features. In this case, the user might start their design with actions targeted at optimizing the features that will result in an artifact that can be used in a specific way; starting at this point will shape what they subsequently do-their preferences over aesthetic features will be different as a result of their functional choices. The opposite pattern may emerge for designers who begin with aesthetic choices. Additionally, individuals may have varying preferences over the order and extent to which they implement visual features.

Generative artificial intelligence (AI) tools excel in producing novel and unconventional designs. Unfortunately, generative AI tools can fall short in generating designs that serve as effective starting points for the design process. Various aspects of the present disclosure are directed to human-in-the-loop simulated annealing. In particular, various aspects of the present disclosure are directed to capturing the design preferences of human product designers in a setting where they are seeking to create a car, robot, or other technology product using generative AI. In practice, a designer begins with an abstract idea or feeling that they want to express in a product and uses it as a text “seed” for the product. These aspects of the present disclosure present the human designer with multiple product designs, produced by randomly sampling an embedding space, to rate and provide feedback. These aspects of the present disclosure then employ a simulated annealing process to generate innovative designs that consider the designer's feedback and preferences.

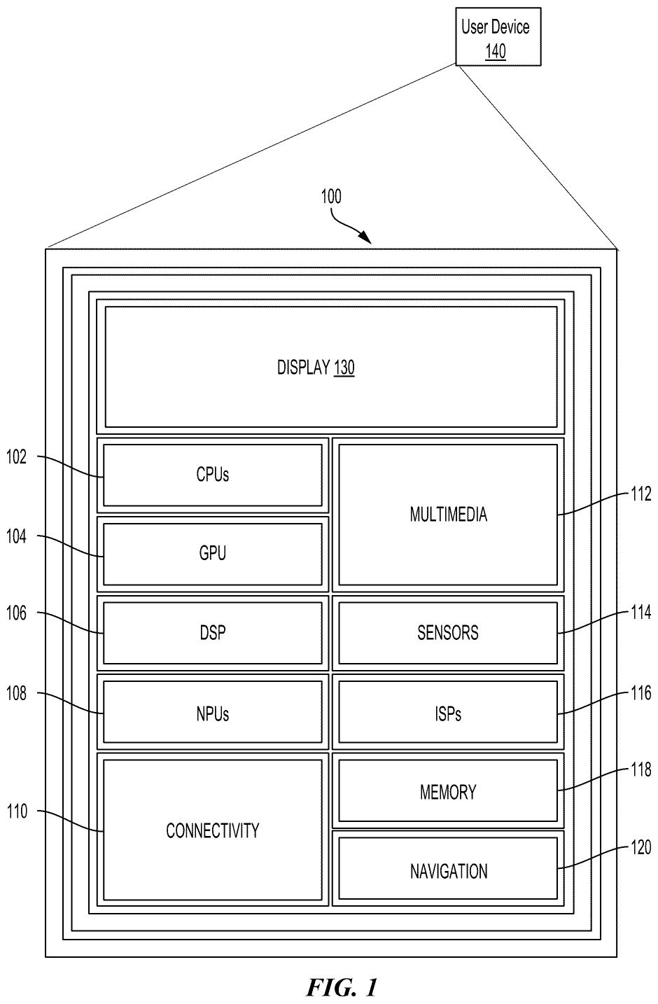

FIG. 1 illustrates an example implementation of the aforementioned system and method for a visual content creation system using a system-on-a-chip (SOC) 100, according to aspects of the present disclosure. The SOC 100 may include a single processor or multi-core processors (e.g., a central processing unit (CPU) 102), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, select a control action, according to the display 130 illustrating a view of a user device.

In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system. The SOC 100 may be based on an Advanced Risc Machine (ARM) instruction set, RISC-V, or any reduced instruction set computing (RISC) architecture, or the like. In another aspect of the present disclosure, the SOC 100 may be a server computer in communication with a user device 140. In this arrangement, the user device 140 may include a processor and other features of the SOC 100.

In this aspect of the present disclosure, instructions loaded into a processor (e.g., CPU 102) or the NPU 108 may include code to generate an innovative design with a simulated annealing process using a generative artificial intelligence (AI) model. The instructions loaded into a processor (e.g., NPU 108) may also include code to present a human product designer with multiple product designs, produced by randomly sampling an embedding space of the generative AI model, to rate and provide feedback by the human product designer. The instructions loaded into the processor (e.g., NPU 108) may also include code to generate a fitness function over the embedding space of the generative AI model, in which a score estimation model is fitted on scored vectors of the embedding space to assign a high/low probability to samples with a high/low score from the human product designer. The instructions loaded into the processor (e.g., NPU 108) may also include code to employ a simulated annealing process to generate innovative designs that consider the designer's feedback and preferences, in which the score estimation model is modified by multiplying variances of the score estimation model with a current temperature T, and renormalization. The instructions loaded into the processor (e.g., NPU 108) may also include code to explore, by the human product designer, a design space of the generative AI model identified according to the score estimation model.

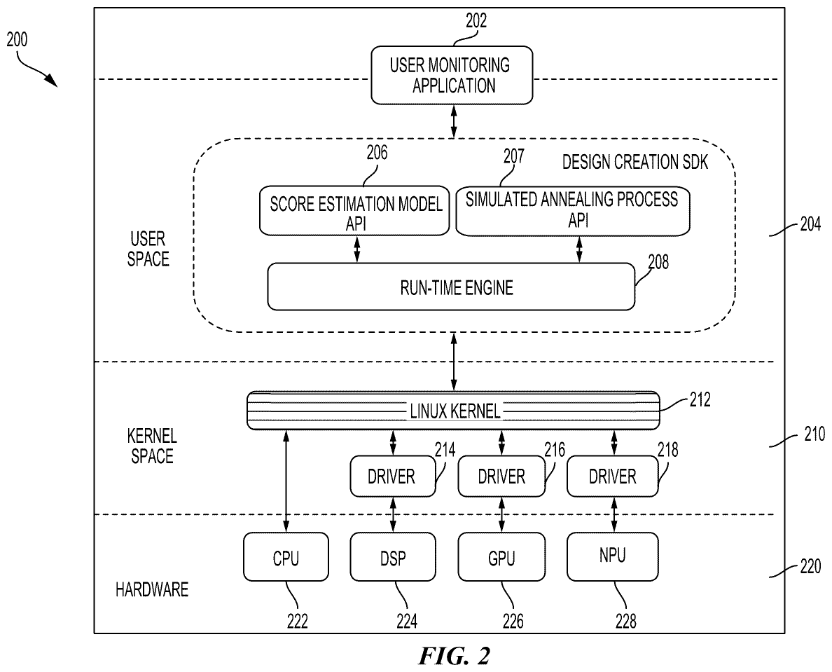

FIG. 2 is a block diagram illustrating a software architecture 200 that may modularize artificial intelligence (AI) functions for a visual content design system, according to aspects of the present disclosure. Using the architecture, a user monitoring application 202 may be designed such that it may cause various processing blocks of an SOC 220 (for example a CPU 222, a DSP 224, a GPU 226, and/or an NPU 228) to perform supporting computations during run-time operation of the user monitoring application 202. FIG. 2 describes the software architecture 200 for a visual content design system. It should be recognized that the visual content design system is not limited to any specific information. According to aspects of the present disclosure, the user monitoring and the visual content design functionality is applicable to any type of information access activity.

The user monitoring application 202 may be configured to call functions defined in a user space 204 that may, for example, provide visual content design services. The user monitoring application 202 may make a request for compiled program code associated with a library defined in a score estimation model application programming interface (API) 206. The score estimation model API 206 is configured to generate a fitness function over the embedding space of the generative AI model. The score estimation model API 206 is further configured to fit a score estimation model on scored vectors of the embedding space to assign a high/low probability to samples with a high/low score assigned from the human product designer.

In response, compiled program code of a simulated annealing process API 207 is configured to employ a simulated annealing process to generate innovative designs that consider the designer's feedback and preferences. In various aspects of the present disclosure, the simulated annealing process API 207 modifies the score estimation model API 206 by multiplying variances of the score estimation model API 206 with a current temperature T, and renormalization. Additionally, the simulated annealing process API 207 is configured to enable human product designer exploration of a design space of the generative AI model identified according to the score estimation model API 206.

A run-time engine 208, which may be compiled code of a run-time framework, may be further accessible to the user monitoring application 202. The user monitoring application 202 may cause the run-time engine 208, for example, to take actions for recommendations of design alternatives to improve the design of visual content. In response to recommendation of visual content, the run-time engine 208 may in turn send a signal to an operating system 210, such as a Linux Kernel 212, running on the SOC 220. FIG. 2 illustrates the Linux Kernel 212 as software architecture for a visual content creation system. It should be recognized, however, that aspects of the present disclosure are not limited to this exemplary software architecture. For example, other kernels may provide the software architecture to support the visual content design functionality.

The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228 if present.

As noted above, existing tools rely on designers to search for inspiration separately (e.g., searching Pinterest) or to passively evaluate completed designs in order to infer their preferred designs (e.g., preference learning). Recently, generative artificial intelligence (AI) tools excel in producing novel and unconventional designs. Unfortunately, generative AI tools can fall short in generating designs that serve as effective starting points for the design process. In practice, a designer begins with an abstract idea or feeling that they want to express in a product and uses it as a text “seed” for the product.

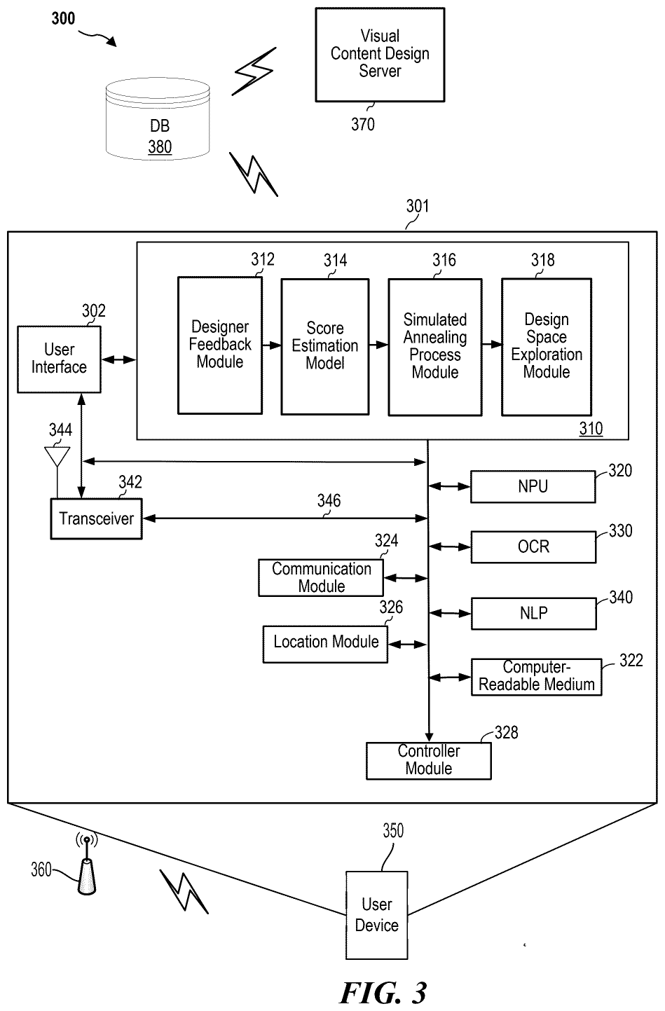

Various aspects of the present disclosure are directed to human-in-the-loop simulated annealing. In particular, various aspects of the present disclosure are directed to capturing the design preferences of human product designers in a setting where they are seeking to create a car, robot, or other technology product using generative AI. These aspects of the present disclosure present the human designer with multiple product designs, produced by randomly sampling an embedding space, to rate and provide feedback. These aspects of the present disclosure then employ a simulated annealing process to generate innovative designs that consider the designer's feedback and preferences, for example, as shown in FIG. 3.

FIG. 3 is a diagram illustrating a hardware implementation for a visual content design system 300, according to aspects of the present disclosure. The visual content design system 300 may be configured to present the human designer with multiple product designs, produced by randomly sampling an embedding space, to rate and provide feedback. The visual content design system 300 then employs a simulated annealing process to generate innovative designs that consider the designer's feedback and preferences. The visual content design system 300 then enables a human product designer to explore a design space of the generative AI model identified according to a score estimation model.

The visual content design system 300 includes a user monitoring system 301 and a visual content design server 370 in this aspect of the present disclosure. The user monitoring system 301 may be a component of a user device 350. The user device 350 may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a Smartbook, an Ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a global positioning system device, or any other suitable device that is configured to communicate via a wireless or wired medium.

The visual content design server 370 may connect to the user device 350 for tracking actions as the designers perform their tasks (e.g., user actions within a design application such as AutoCAD) to tailor the types of presented alternatives to the individual. For example, the visual content design server 370 may apply score estimation models for each designer and their product rating to an embedding space of a generative AI model. Additionally, the visual content design server 370 may also present design spaces of the generative AI model that are identified by a score estimation model for designer exploration, thus augmenting design creativity.

The user monitoring system 301 may be implemented with an interconnected architecture, represented by an interconnect 346, which may be implemented as a controller area network (CAN). The interconnect 346 may include any number of point-to-point interconnects, buses, and/or bridges depending on the specific application of the user monitoring system 301 and the overall design constraints. The interconnect 346 links together various circuits including one or more processors and/or hardware modules, represented by a user interface 302, a user activity module 310, a neural network processor (NPU) 320, a computer-readable medium 322, a communication module 324, a location module 326, a controller module 328, an optical character recognition (OCR) 330, and a natural language processor (NLP) 340. The interconnect 346 may also link various other circuits such as timing sources, peripherals, voltage regulators, and power management circuits, which are well known in the art, and therefore, will not be described any further.

The user monitoring system 301 includes a transceiver 342 coupled to the user interface 302, the user activity module 310, the NPU 320, the computer-readable medium 322, the communication module 324, the location module 326, the controller module 328, the OCR 330, and NLP 340. The transceiver 342 is coupled to an antenna 344. The transceiver 342 communicates with various other devices over a transmission medium. For example, the transceiver 342 may receive commands via transmissions from a user. In this example, the transceiver 342 may receive/transmit information for the user activity module 310 to/from connected devices within the vicinity of the user device 350.

The user monitoring system 301 includes the NPU 320, the OCR 330, and the NLP 340 coupled to the computer-readable medium 322. The NPU 320, the OCR 330, and NLP 340 performs processing, including the execution of software stored on the computer-readable medium 322 to provide a score estimation model for user monitoring and identifying design spaces of a generative AI model, according to the present disclosure. The software, when executed by the NPU 320, the OCR 330 and the NLP 340, causes the user monitoring system 301 to perform the various functions described for presenting analogies to clarify statistical data presented to the user through the user device 350, or any of the modules (e.g., 310, 324, 326, and/or 328). The computer-readable medium 322 may also be used for storing data that is manipulated by the OCR 330 and the NLP 340 when executing the software to analyze user communications.

The location module 326 may determine a location of the user device 350. For example, the location module 326 may use a global positioning system (GPS) to determine the location of the user device 350. The location module 326 may implement a dedicated short-range communication (DSRC)-compliant GPS unit. A DSRC-compliant GPS unit includes hardware and software to make the user device 350 and/or the location module 326 compliant with the following DSRC standards, including any derivative or fork thereof: EN 12253:2004 Dedicated Short-Range Communication-Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); and EN ISO 14906:2004 Electronic Fee Collection—Application interface.

The communication module 324 may facilitate communications via the transceiver 342. For example, the communication module 324 may be configured to provide communication capabilities via different wireless protocols, such as 5G new radio (NR), Wi-Fi, long term evolution (LTE), 4G, 3G, etc. The communication module 324 may also communicate with other components of the user device 350 that are not modules of the user monitoring system 301. The transceiver 342 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

The user monitoring system 301 also includes the OCR 330 and the NLP 340 to automatically detect multiple objects in an image displayed on the user's workspace. The user monitoring system 301 may follow a process to detect and determine whether the user accesses creative content. When the user curates images, the user monitoring system 301 utilizes the OCR 330 and/or the NLP 340 to analyze designs of detected objects in the image displayed on the user's workspace.

The user activity module 310 may be in communication with the user interface 302, the NPU 320, the computer-readable medium 322, the communication module 324, the location module 326, the controller module 328, the OCR 330, the NLP 340, and the transceiver 342. In one configuration, the user activity module 310 monitors communications from the user interface 302. The user interface 302 may monitor user communications to and from the communication module 324. According to aspects of the present disclosure, the OCR 330 and the NLP 340 automatically detect images displayed on the user's workspace and may use computer vision object detection and instance segmentation techniques to automatically detect the objects in the image to enable design action pattern analysis to enable determination of design alternatives for a user.

As shown in FIG. 3, the user activity module 310 includes a designer feedback module 312, a score estimation model 314, a simulated annealing process module 316, and a design space exploration module 318. The designer feedback module 312, the score estimation model 314, the simulated annealing process module 316, and the design space exploration module 318 may be components of a same or different artificial neural network, such as a deep convolutional neural network (CNN). The user activity module 310 is not limited to a CNN, and may include a Gaussian Mixture Model, a minimum layer perceptron (MLP) or another like neural network. The user activity module 310 monitors and analyzes designs displayed on the user's workspace from the user interface 302.

This configuration of the user activity module 310 includes the designer feedback module 312 configured to present a human product designer with multiple product designs. For example, the multiple product designs are produced by randomly sampling an embedding space of the generative AI model, to receive ratings and feedback by the human product designer. In various aspects of the present disclosure, the embedding space of the generative AI model is generated in response to an initial text description of a product desired for development by the designer. Additionally, presenting the human product designer with multiple product designs, including randomly sampling latent vectors from the embedding space of the generative AI model.

In various aspects of the present disclosure, the user activity module 310 includes the score estimation model 314 in which the score estimation model 314 is fitted on scored vectors of the embedding space to generate a fitness function over the embedding space of the generative AI model. According to various aspects of the present disclosure, the fitness function over the embedding space of the generative AI model assigns a high/low probability to samples with a high/low score from the human product designer. For example, the fitness function assigns a high value in parts of the embedding space that the designer rated positively, and low value in parts of the embedding space that the designer rated negatively. In various aspects of the present disclosure, score assignment is accomplished by fitting a Gaussian Mixture Model on the scored latent vectors, assigning a high probability to the samples with a high score, and a low probability to the samples that were given a low score by the designer.

In this example, the user activity module 310 also includes the simulated annealing process module 316 configured to employ a simulated annealing process to generate innovative designs that consider the designer's feedback and preferences. In these aspects of the present disclosure, the score estimation model 314 is modified by multiplying variances of the score estimation model 314 with a current temperature T, and renormalization, effectively “smudging” the probability over the embedding space. Over several iterations, the “smudged” distribution will become less and less smudged as the temperature T is decreased. The simulated annealing approach allows us to explore various parts of the latent space and present many options to the designer, without converging prematurely. Premature convergence would fixate quickly on the first round of feedback provided by the designer, and yield results with lower creativity.

As shown in FIG. 3, the user activity module 310 includes the design space exploration module 318 configured to explore, by the human product designer, a design space of the generative AI model identified according to the score estimation model 314. By using the generative AI in conjunction with the simulated annealing process module 316, the designer can quickly explore the possible design space using the design space exploration module 318. In various aspects of the present disclosure, the visual content design system 300 can iteratively learn the preferences or feelings that the designer is trying to express and help to focus in on that idea. The design space exploration module 318 is configured to display the design alternatives recommended to the individual designer based on the score estimation model 314 and the simulated annealing process module 316.

In some aspects of the present disclosure, the visual content design system 300 expedites the design process and reduces costs associated with manual design. This expedited design process is helpful for businesses to stay ahead of their competition by generating novel and unique designs that can catch the attention of consumers. Additionally, the simulated annealing process module 316 allows for the continuous refinement of designs based on feedback from human designers. This enables the simulated annealing process module 316 to learn and adapt to the designer's preferences over time, resulting in better designs that are tailored to the company's specifications.

Various aspects of the present disclosure are particularly beneficial for businesses operating in competitive markets where differentiation and innovation are key factors for success. For example, designing a new car, robot, or other product from scratch can be a time-consuming process. Designers often start with a vague idea or feeling that they want to express but may struggle to concretize the expression of their idea in the specific product. By using the visual content design system 300, the designer can quickly explore the possible design space, and the visual content design system 300 can iteratively learn the preferences or feelings that the designer is trying to express and help to focus in on that idea. In various aspects of the present disclosure, the simulated annealing process module 316 provides the ability to generate diverse and wacky design ideas for helping designers think creatively and create innovative automotive or robotic designs that stand out from the competition. At the same time, the human designer's feedback can ensure that the designs are functional and meet the company's specifications for the product's intended purpose. Beneficially, the visual content design system 300 provides a valuable tool for businesses that want to innovate and create new products quickly and efficiently.

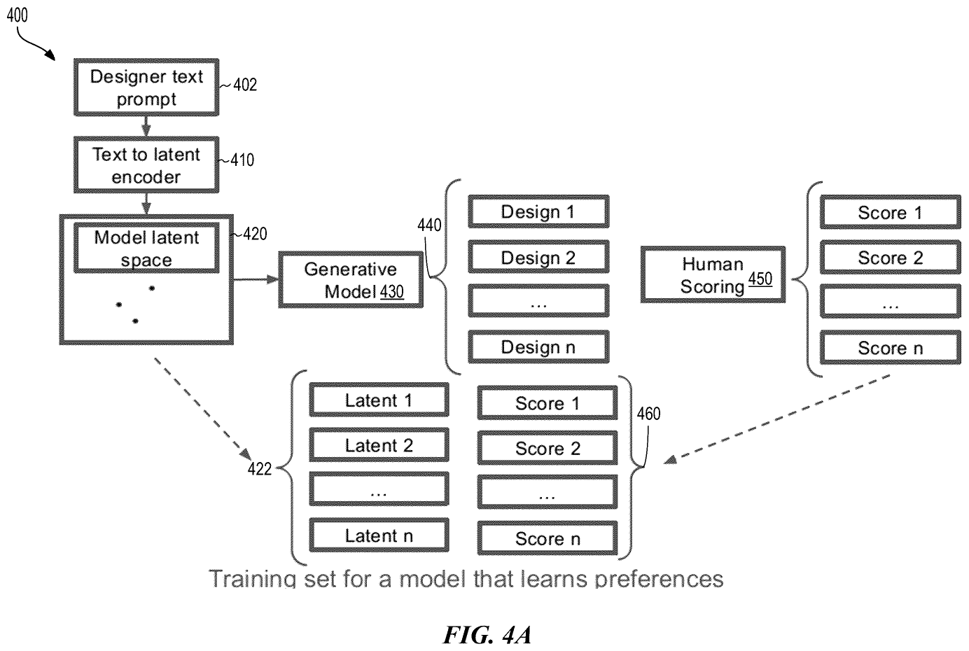

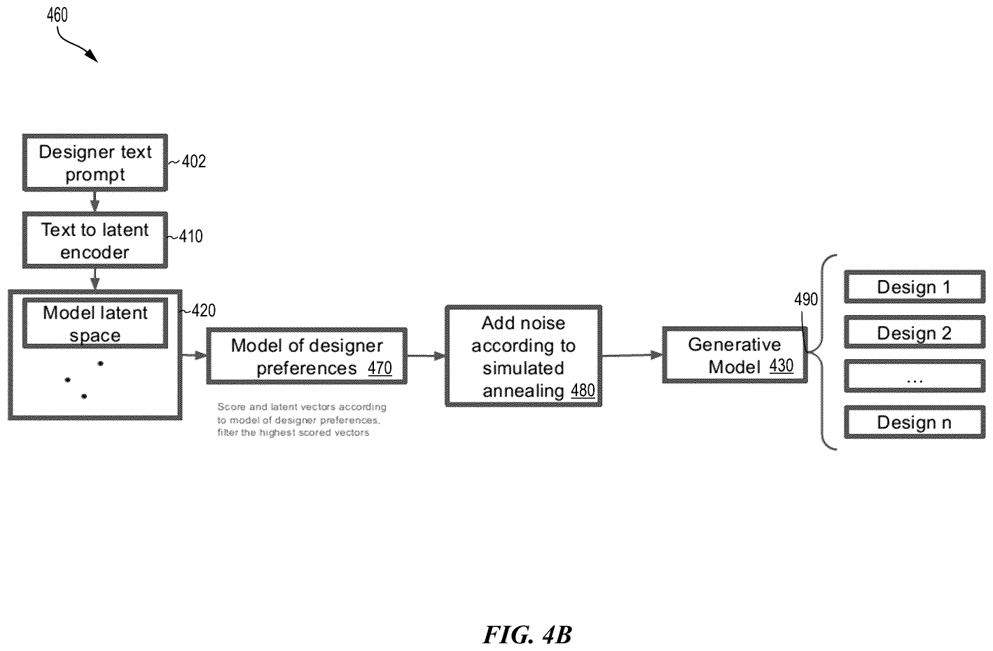

In some aspects of the present disclosure, the user activity module 310 may be implemented and/or work in conjunction with the visual content design server 370. In one configuration, a database (DB) 380 stores data related to designs of images/objects as well as previously designed images/objects, which may be displayed as output through the user interface 302. In some aspects of the present disclosure, the visual content design system 300 may be implemented as a web browser plugin. In other aspects of the present disclosure, the visual content design server 370 provides an offline application that scans content viewed through the user interface 302. In other aspects of the present disclosure, the visual content design system 300 may be implemented as a mobile application that augments the visual content design process by recommending design alternatives through the user interface 302, for example, as shown in FIGS. 4A and 4B.

FIGS. 4A and 4B are block diagrams illustrating a visual content design recommendation system, according to various aspects of the present disclosure. FIGS. 4A and 4B illustrate a process for generating an innovative design with a simulated annealing process using a generative artificial intelligence (AI) model, according to various aspects of the present disclosure.

FIG. 4A illustrates an initial run of a process 400 without the model of designer preferences and shows how training data for the model of designer preferences can be extracted from the initial run of the system. In this example, a designer text prompt 402 is supplied by a human product designer. For example, the designer text prompt 402 may represent an initial text description of a product desired for development by the human product designer. In response to the designer text prompt 402, a text to latent encoder 410 generates a model latent space 420 based on the product desired for development by the human product designer. The model latent space 420 is composed of latent spaces 422 (e.g., Latent 1, Latent 2, . . . , Latent n).

According to various aspects of the present disclosure, a generative AI model 430 generates various product designs 440 (e.g., Design 1, Design 2, . . . , Design n) based on the latent spaces 422. In example, the various product designs 440 are present to the human product designer for scoring the various product designs 440 at a human scoring module 450, which generate the scores 452 (e.g., Score 1, Score 2, . . . , Score n). In this example, the human product designer is presented with multiple product designs 440, produced by randomly sampling the model latent space 420 of the generative AI model 430 to receive rating and feedback from the human product designer as part of the human scoring module 450 to generate the scores 452. In some implementations, physiological signals of the human product designer are monitored to determine the ratings and feedback received from the human product designer. According to various aspects of the present disclosure, the latent spaces 422 and the scores 452 provide a training set for a model that learns the preferences of the human product designer, as further illustrated in FIG. 4B.

FIG. 4B further illustrates the process 400 of FIG. 4A, according to various aspects of the present disclosure. As shown in FIG. 4B, a process 460 includes a trained, model of designer preference, for example, based on the latent spaces 422 and the scores 452, as shown in FIG. 4A. In this example, the trained, model of designer preferences 470 is incorporated into the process 460, which omits the downstream designer. According to various aspects of the present disclosure, the human product designer has the ability to provide new scores to the various product designs 440, and the model of designer preferences 470 can be retrained continuously.

As shown in FIG. 4B, the designer text prompt 402, the text to latent encoder 410 and the model latent space 420 are provided to generate the model of designer preferences 470. In some implementations, the trained, model of designer preferences 470 predict new latent spaces and the scores for filtering the highest scored vectors. In some implementations, a fitness function is generated over the embedding space of the generative AI model, in which the model of designer preferences 470 is fitted on scored latent vectors of the embedding space to assign a high/low probability to the samples with a high/low score from the human product designer.

In various aspects of the present disclosure, noise is added to the model of designer preferences 470 as part of a simulated annealing 480. For example, the process 460 employs a simulated annealing process to generate innovative designs in response to the designer's feedback and preferences, in which the model of designer preferences 470 is modified by multiplying variances of the model of designer preferences 470 by a current temperature T, and renormalization. In response, the generative AI model 43 generates designs 490.

According to various aspects of the present disclosure, the human product designer explores a design space of the generative AI model 430 identified according to the model of designer preferences 470 to explore the designs 490. In some implementations, an emotional state of the human product designer monitor and the amount of time that has passed in the given session are used to determine a new temperature T as part of the simulated annealing 480. Additionally, the simulated annealing 480 may include reducing the temperature T according to a predetermined schedule. For example, a new temperature includes a smudging factor in a next iteration of the simulated annealing 480.

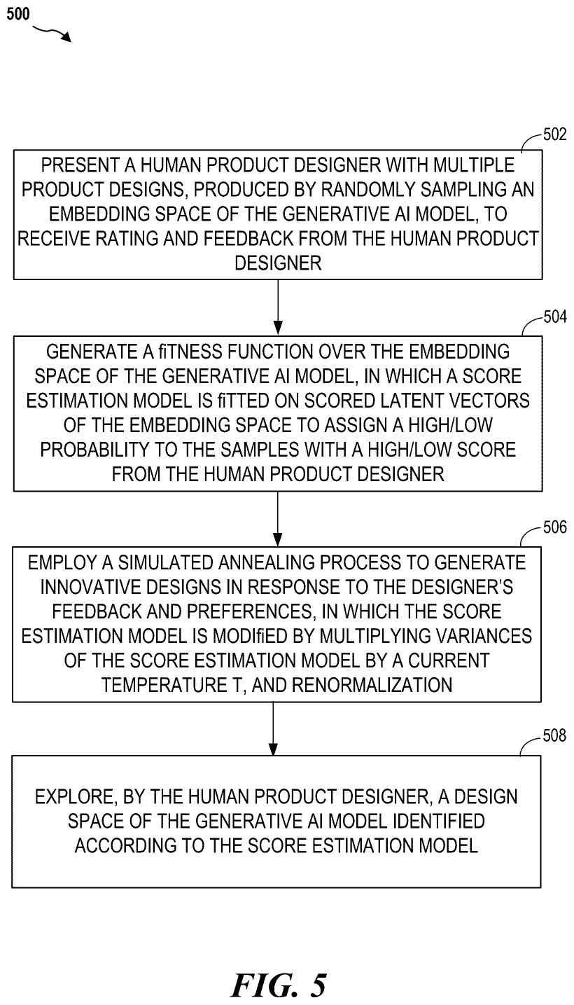

FIG. 5 is a process flow diagram illustrating a method 500 for generating an innovative design with a simulated annealing process using a generative artificial intelligence (AI) model, according to aspects of the present disclosure. The method begins at block 502, in which a human product designer is presented with multiple product designs, produced by randomly sampling an embedding space of a generative AI model, to receive rating and feedback from the human product designer. For example, as shown in FIG. 4A, the human product designer is presented with multiple product designs 440, produced by randomly sampling the model latent space 420 of the generative AI model 430 to receive rating and feedback from the human product designer as part of the human scoring module 450 to generate the scores 452.

According to various aspects of the present disclosure, the latent spaces 422 and the scores 452 provide a training set for a model that learns the preferences of the human product designer, as further illustrated in FIG. 4B.

At block 504, a fitness function is generated over the embedding space of the generative AI model, in which a score estimation model is fitted on scored latent vectors of the embedding space to assign a high/low probability to the samples with a high/low score from the human product designer. For example, as shown in FIG. 4B, the trained, model of designer preferences 470 predict new latent spaces and the scores for filtering the highest scored vectors. In some implementations, a fitness function is generated over the embedding space of the generative AI model, in which the model of designer preferences 470 is fitted on scored latent vectors of the embedding space to assign a high/low probability to the samples with a high/low score from the human product designer.

At block 706, a simulated annealing process is employed to generate innovative designs in response to the designer's feedback and preferences, in which the score estimation model is modified by multiplying variances of the score estimation model by a current temperature T, and renormalization. For example, as shown in FIG. 4B, the process 460 employs a simulated annealing process to generate innovative designs in response to the designer's feedback and preferences, in which the model of designer preferences 470 is modified by multiplying variances of the model of designer preferences 470 by a current temperature T, and renormalization. In response, the generative AI model 43 generates designs 490.

At block 708, the human product designer explores a design space of the generative AI model identified according to the score estimation model. For example, as shown in FIG. 4B, the human product designer explores a design space of the generative AI model 430 generated according to the model of designer preferences 470 by exploring the designs 490.

Various aspects of the present disclosure are particularly beneficial for businesses operating in competitive markets where differentiation and innovation are key factors for success. For example, designing a new car, robot, or other product from scratch can be a time-consuming process. Designers often start with a vague idea or feeling that they want to express but may struggle to concretize the expression of their idea in the specific product. By using a generative AI tool in conjunction with a human-in-the-loop simulated annealing, the designer can quickly explore the possible design space. The tool can iteratively learn the preferences or feelings that the designer is trying to express and help to focus in on that idea.

In various aspects of the present disclosure, a human-in-the-loop simulated annealing tool provides the ability to generate diverse and wacky design ideas for helping designers think creatively and create innovative automotive or robotic designs that stand out from the competition. At the same time, the human designer's feedback can ensure that the designs are functional and meet the company's specifications for the product's intended purpose. Beneficially, the human-in-the-loop simulated annealing provides a valuable tool for businesses that want to innovate and create new products quickly and efficiently. The competitive advantage of the human-in-the-loop simulated annealing tool lies in its ability to combine the creative and innovative power of generative AI with the expertise and feedback of human product designers. By using this tool, businesses can leverage the strengths of both AI and human designers to create new products that stand out in the market.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but, in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM, flash memory, ROM, programmable read-only memory (PROM), EPROM, EEPROM, registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in several ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for generating an innovative design with a simulated annealing process using a generative artificial intelligence (AI) model, comprising:
presenting a human product designer with multiple product designs, produced by randomly sampling an embedding space of the generative AI model, to receive rating and feedback from the human product designer;
generating a fitness function over the embedding space of the generative AI model, in which a score estimation model is fitted on scored latent vectors of the embedding space to assign a high/low probability to the samples with a high/low score from the human product designer;
employing a simulated annealing process to generate innovative designs in response to feedback and preferences of the human product designer, in which the score estimation model is modified by multiplying variances of the score estimation model by a current temperature T, and renormalization; and
exploring, by the human product designer, a design space of the generative AI model identified according to the score estimation model.

2. The method of claim 1, in which the embedding space of the generative AI model is generated in response to an initial text description of a product desired for development by the human product designer.

3. The method of claim 1, in which presenting the human product designer comprises randomly sampling latent vectors from the embedding space of the generative AI model.

4. The method of claim 1, further comprising monitoring physiological signals of the human product designer to determine the ratings and feedback received from the human product designer.

5. The method of claim 1, in which employing the simulated annealing process further comprises learning and adapting preferences of the human product designer over time.

6. The method of claim 1, in which employing the simulated annealing process comprises reducing the temperature T according to a predetermined schedule.

7. The method of claim 6, further comprising monitoring an emotional state of the human product designer and an amount of time that has passed in the given session to determine a new temperature T.

8. The method of claim 7, in which the new temperature comprises a smudging factor in a next iteration of the simulated annealing.

9. A non-transitory computer-readable medium having program code recorded thereon for generating an innovative design with a simulated annealing process using a generative artificial intelligence (AI) model, the program code being executed by a processor and comprising:
program code to present a human product designer with multiple product designs, produced by randomly sampling an embedding space of the generative AI model, to receive rating and feedback from the human product designer;
program code to generate a fitness function over the embedding space of the generative AI model, in which a score estimation model is fitted on scored latent vectors of the embedding space to assign a high/low probability to the samples with a high/low score from the human product designer;
program code to employ a simulated annealing process to generate innovative designs in response to feedback and preferences of the human product designer, in which the score estimation model is modified by multiplying variances of the score estimation model by a current temperature T, and renormalization; and
program code to explore, by the human product designer, a design space of the generative AI model identified according to the score estimation model.

10. The non-transitory computer-readable medium of claim 9, in which the embedding space of the generative AI model is generated in response to an initial text description of a product desired for development by the human product designer.

11. The non-transitory computer-readable medium of claim 9, in which the program code to present the human product designer comprises program code to randomly sample latent vectors from the embedding space of the generative AI model.

12. The non-transitory computer-readable medium of claim 9, further comprising program code to monitor physiological signals of the human product designer to determine the ratings and feedback received from the human product designer.

13. The non-transitory computer-readable medium of claim 9, in which the program code to employ the simulated annealing process further comprises program code to learn and adapt preferences of the human product designer over time.

14. The non-transitory computer-readable medium of claim 9, in which the program code to employ the simulated annealing process comprises program code to reduce the temperature T according to a predetermined schedule.

15. The non-transitory computer-readable medium of claim 14, further comprising program code to monitor an emotional state of the human product designer and an amount of time that has passed in the given session to determine a new temperature T.

16. The non-transitory computer-readable medium of claim 15, in which the new temperature comprises a smudging factor in a next iteration of the simulated annealing.

17. A system for generating an innovative design with a simulated annealing process using a generative artificial intelligence (AI) model, the system comprising:
a designer feedback module to present a human product designer with multiple product designs, produced by randomly sampling an embedding space of the generative AI model, to receive rating and feedback from the human product designer;
a score estimation model to generate a fitness function over the embedding space of the generative AI model, in which a score estimation model is fitted on scored latent vectors of the embedding space to assign a high/low probability to the samples with a high/low score from the human product designer;
a simulated annealing process module to employ a simulated annealing process to generate innovative designs in response to feedback and preferences of the human product designer, in which the score estimation model is modified by multiplying variances of the score estimation model by a current temperature T, and renormalization; and
a design space exploration module to explore, by the human product designer, a design space of the generative AI model identified according to the score estimation model.

18. The system of claim 17, in which the embedding space of the generative AI model is generated in response to an initial text description of a product desired for development by the human product designer.

19. The system of claim 17, in which the score estimation module is further to monitor physiological signals of the human product designer to determine the ratings and feedback received from the human product designer.

20. The system of claim 17, in which the simulated annealing process module is further to learn and adapt preferences of the human product designer over time.
